(19) United States
(12) Patent Application Publication
(10) Pub. No.: US 2016/0180793 A1
(43) Pub. Date: Jun. 23, 2016

(54) DISPLAY DEVICE

(71) Applicant: Samsung Display Co., Ltd., Yongin-city (KR)

(72) Inventors: Kyungsik KIM, Asan-si (KR); Joo-suk Lee, Asan-si (KR); Seungjae Kang, Asan-si (KR); Hasook Kim, Asan-si (KR); Jang-hyun Yeo, Seoul (KR)

(21) Appl. No.: 14/809,895

(22) Filed: Jul. 27, 2015

(30) Foreign Application Priority Data
Dec. 23, 2014 (KR) 10-2014-0186994

(51) Int. Cl. G09G 3/36

(52) U.S. Cl. CPC G09G 3/3696; G09G 2330/00

(57) ABSTRACT

A display device including a first substrate comprising pixels, a second substrate facing the first substrate, and a power supply unit disposed on a peripheral area of the first substrate that does not overlap the second substrate.

### CROSS-REFERENCE TO RELATED APPLICATION

This application claims priority from and the benefit of Korean Patent Application No. 10-2014-0186994, filed on Dec. 23, 2014, which is hereby incorporated by reference for all purposes as if fully set forth herein.

### BACKGROUND

1. Field

Exemplary embodiments of the present invention relate to a display device, and more particularly, to a display device in which a size of a printed circuit board may be reduced.

2. Discussion of the Background

Display devices may include a display panel for displaying images, and a gate driving unit and a data driving unit to drive the display panel. The display panel may include is gate lines, data lines, and pixels connected to the gate lines and data lines. The gate lines may receive gate signals from a gate driving circuit. The data lines may receive data voltages from the data driving unit. In response to gate signals supplied through the gate lines, pixels may receive data voltages through the data lines. The pixels may display a grayscale that correspond to the data voltages to display images.

The display device may further include a printed circuit board on which a timing controller for controlling the gate driving unit and the data driving unit is mounted. Multiple components, such as the timing controller and signal lines for transmitting signals between the components, may be mounted on the printed circuit board.

As the display panel becomes larger, the overall size of the printed circuit board tends to become smaller. As a result, technologies for reducing the number of primary components mounted on the printed circuit boards are being developed.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention provide a display device that may reduce the size of a printed circuit board.

Additional aspects will be set forth in the detailed description which follows, and, in part, will be apparent from the disclosure, or may be learned by practice of the inventive concept.

According to an exemplary embodiment of the present invention, a display devices includes a first substrate including pixels, a second substrate connected to and facing the first substrate, and a power supply unit disposed on a peripheral area of the first substrate that does not overlap the second substrate.

The display device may further include data driving chips disposed on the peripheral area of the first substrate by a chip-on-glass method.

The power supply unit may be electrically connected to the data driving chips and configured to supply an analog driving voltage to the data driving chips.

The first substrate may further include a display area on which images are configured to be displayed and a black matrix area surrounding the display area.

The display device may further include a gate driving circuit disposed on the black matrix area.

The power supply unit may be electrically connected to the gate driving circuit to supply a gate-on voltage to the gate driving circuit.

Gate lines electrically connected to the pixels and data lines insulated from and crossing the gate lines may be disposed on the display area and the black matrix area.

The display device may further include a first gate driving circuit and a second gate driving circuits disposed on the black matrix area.

The first gate driving circuit may be connected to a first end of the gate lines, and the second gate driving circuit may be connected to a second end of the gate lines, the first end being opposite to the second end.

The display device may further include an auxiliary power supply unit disposed on the peripheral area, in which the power supply unit may be configured to supply a first gate-on voltage to the first gate driving circuit, and the auxiliary power supply unit may be configured to supply a second gate-on voltage to the second gate driving circuit.

According to an exemplary embodiment of the present invention, a display devices includes a first substrate including pixels, a second substrate connected to and facing the first substrate, a driving circuit board electrically connected to the first substrate, a connection unit electrically connecting the first substrate and the driving circuit board, and a power supply unit disposed on the connection unit.

The connection unit may include at least one flexible circuit board.

The connection unit may include first and second flexible circuit boards, the power supply unit may include a first power supply unit and the second power supply unit, and the first and second power supply units may be disposed on the first and second flexible circuit boards, respectively.

The power supply unit may be disposed on the at least one flexible circuit board.

The second substrate may include a common electrode.

The display device may further include a gate driving circuit disposed on a black matrix area of the first substrate, in which the black matrix area surrounds a display area of the first substrate.

The connection unit may include a first flexible circuit board and a second flexible circuit board, the power supply unit may be disposed on the first flexible circuit board, and a first distance from the first flexible circuit board to the gate driving circuit may be less than a second distance from the second flexible circuit board to the gate driving circuit.

The power supply unit may be electrically connected to the gate driving circuit to supply a gate-on voltage to the gate driving circuit, the gate driving circuit may be connected to gate lines disposed on the black matrix area, and the gate lines may be electrically connected to the pixels.

A third distance from the power supply unit to the gate driving circuit may be less than a fourth distance from the driving circuit board to the gate driving circuit.

The foregoing general description and the following detailed description are exemplary and explanatory and are intended to provide further explanation of the claimed subject matter.

### BRIEF DESCRIPTION OF THE DRAWINGS

The accompanying drawings are included to provide a further understanding of the inventive concept, and are incorporated in and constitute a unit of this specification. The drawings illustrate exemplary embodiments of the inventive concept and, together with the description, serve to explain principles of the inventive concept.

FIG. 1 is a block diagram of a display device according to an exemplary embodiment of the present invention.

FIG. 2 is a block diagram illustrating the display device in FIG. 1 including a driving circuit board.

FIG. 3 is a block diagram of a display device according to an exemplary embodiment of the present invention.

FIG. 4 is a block diagram of a display device according to an exemplary embodiment of the present invention.

FIG. 5 is a block diagram of a display device according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, is layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

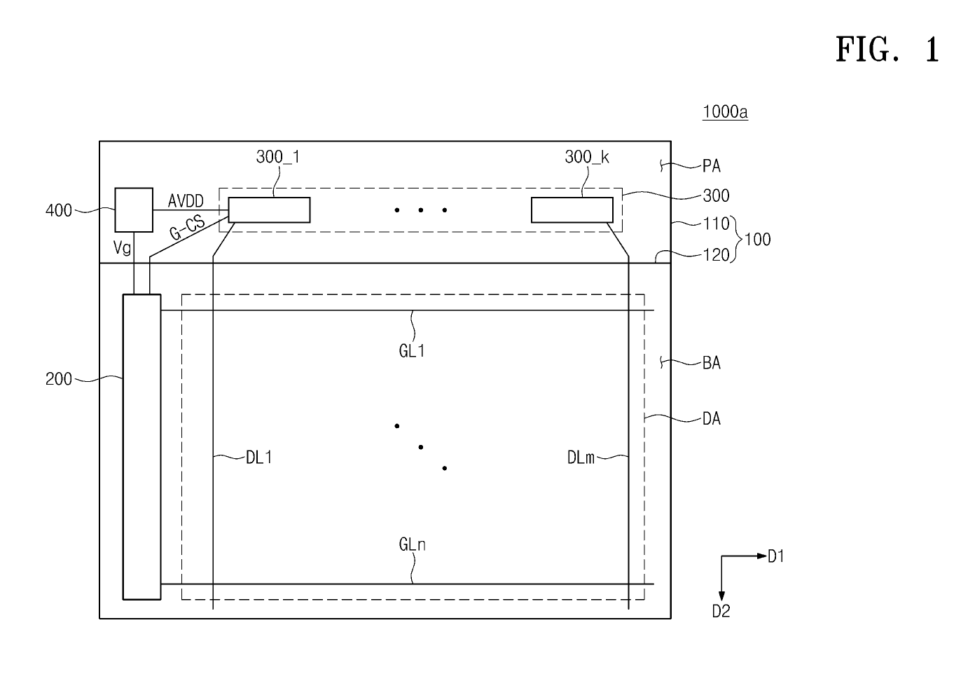

FIG. 1 is a block diagram of a display device according to an exemplary embodiment of the present invention.

Referring to FIG. 1, a display device 1000a includes a display panel 100, a gate driving circuit 200, and a data driving unit 300.

The display panel 100 includes a first substrate 110, a second substrate 120 facing the first substrate 110, and a grayscale control layer (not shown) interposed between the first substrate 110 and the second substrate 120, which may control light transmittance.

According to an exemplary embodiment of the present invention, the display panel 100 may be a liquid crystal display panel including a liquid crystal layer as a grayscale control layer. According to an exemplary embodiment of the present invention, display panels that utilize organic electroluminescence devices or electrophoretic devices may be used as the display panel 100.

Although not illustrated, when the display panel 100 includes the liquid crystal display panel, the display device 1000a may further include a backlight unit mounted on a rear surface of the display panel 100. The backlight unit may be mounted on the rear surface of the display panel 100 and emit light. The backlight unit may use a light emitting diode or a cold cathode fluorescent lamp as a light source.

The display panel 100 includes a display area DA for displaying images, and a black matrix area BA surrounding the display area DA. The display area DA is an area on which images are substantially displayed, and the black matrix area BA is an area on which a black matrix that prevents light leakage is mounted.

On the display area DA, gate lines (GL1 through GLn), data lines (DL1 through DLm), and pixels are disposed. More specifically, the gate lines (GL1 through GLn) extend in a first direction D1, and are arranged in a second direction D2 perpendicular to the first direction D1. The data lines (DL1 through DLm) extend in the second direction D2 and are arranged in the first direction D1. The data lines (DL1 through DLm) and the gate lines (GL1 through GLn) are disposed on respectively different layers to cross each other while being electrically insulated from each other.

Pixel areas are defined on the display area DA by the gate lines (GL1 through GLn) and the data lines (DL1 through DLm). The pixels are respectively mounted on the pixel areas, and each pixel includes a thin-film transistor and a liquid crystal capacitor. The liquid crystal capacitor includes a first electrode and a second electrode, and the liquid crystal layer may be a dielectric that is mounted between the first electrode and the second electrode. The first electrode may be implemented as a pixel electrode and mounted on the first substrate 110. The second electrode may be implemented as a common electrode and mounted on the second substrate 120.

The gate driving circuit 200 is mounted on the black matrix area BA, and may be electrically connected to the gate lines (GL1 through GLn). The gate driving circuit 200 may include stages dependently connected to each other. The stages are electrically connected to the gate lines (GL1 through GLn), respectively, and may output gate signals to the gate lines (GL1 through GLn). The number of the stages included in the gate driving circuit 200 may be n (n is a natural number) or more. For example, the number of the stages may be at least one or more than the number of the gate lines (GL1 through GLn) connected to the gate driving circuit. Each stage includes drive transistors, and each of the drive transistors may be implemented as an amorphous transistor, an oxide semiconductor transistor, or the like.

According to an exemplary embodiment of the present invention, the gate driving circuit 200 may be directly formed on the black matrix area BA of the first substrate 110, through a thin-film process which forms a thin-film transistor of a pixel.

The display panel 100 may further include a peripheral area PA. The peripheral area PA may be an area in which the first substrate 110 is longer than the second substrate 120. Also, pads (not shown) for receiving control signals and image signals transmitted from the outside to the first substrate 110, may be mounted on the peripheral area PA.

According to an exemplary embodiment of the present invention, the data driving unit 300 may be mounted on the peripheral area PA by a chip-on-glass method. More particularly, the data driving unit 300 may be mounted on the peripheral area PA of the first substrate 110, and receive the control signals and the image signals from the outside.

The data driving unit 300 includes data driving chips (300_1 through 300_k). The data driving chips (300_1 through 300_k) may generate data voltages corresponding to the image signals in response to a data control signal transmitted from the outside. The data driving chips (300_1 through 300_k) may output the generated data voltages to the data lines (DL1 through DLm) electrically connected thereto.

A first data driving chip 300_1 of the data driving chips (300_1 through 300_k) is electrically connected to the gate driving circuit 200 to transmit a gate control signal G-CS.

The power supply unit 400 may be electrically connected to the gate driving circuit 200 and the data driving unit 300, and output driving voltages required to operate the gate driving circuit 200 and the data driving unit 300.

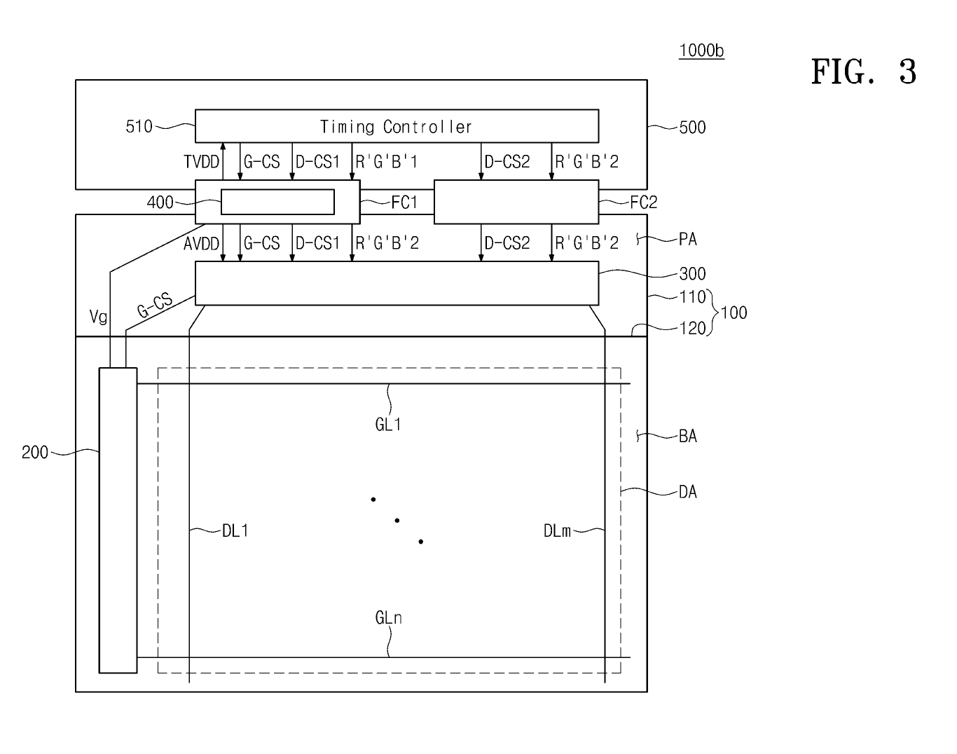

According to an exemplary embodiment of the present invention, the power supply unit 400 may be mounted on the peripheral area PA of the first substrate 110. More specifically, the power supply unit 400 may be mounted in the vicinity of a left side of the peripheral area PA adjacent to the gate driving circuit 200. Alternatively, the mounting structure of the power supply unit 400 may be variously modified. The method of mounting the power supply unit 400 on the peripheral area PA will be described in more detail with reference to FIGS. 3 through 5.

The power supply unit 400 may generate an analog driving voltage AVDD, a gate driving voltage Vg, and a common voltage supplied to the second substrate 120, by using an external power supply voltage. The power supply unit 400 may supply the gate driving voltage Vg to the gate driving circuit 200 for generating the gate signal outputted to each gate line. The power supply unit 400 may also supply the analog driving voltage AVDD to the data driving unit 300 for generating the data voltage outputted to each data line. The power supply unit 400 may supply the common voltage to a common electrode (not shown) disposed on the second substrate 120.

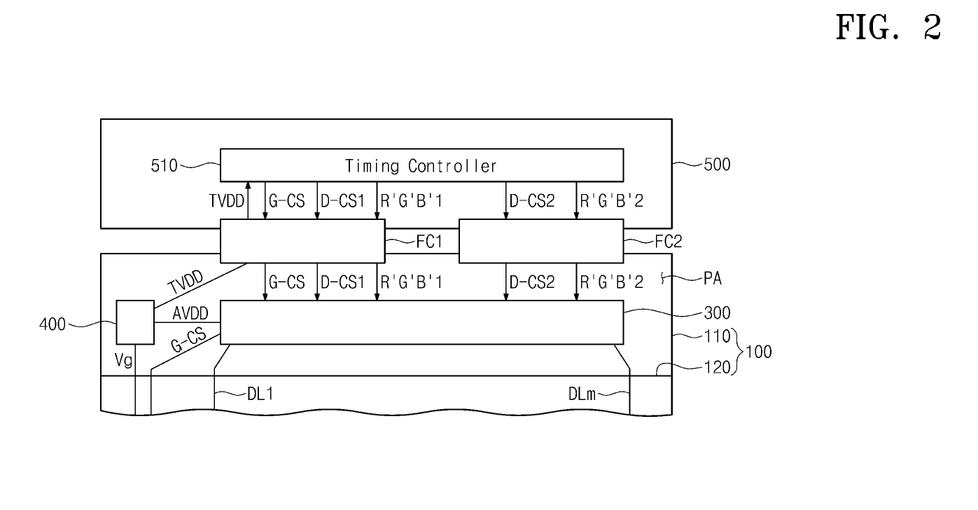

FIG. 2 is a block diagram illustrating the display device in FIG. 1 including a driving circuit board.

Referring to FIGS. 1 and 2, the display device 1000a may further include a first connection unit FC1, a second connection unit FC2, and a driving circuit board 500.

The first and second connection units FC1 and FC2 may electrically connect the display panel 100 and the driving circuit board 500 to each other. More specifically, the first connection unit FC1 may be electrically connected to the data driving unit 300, the power supply unit 400, and a timing controller 510. The first connection unit FC1 may be electrically connected to the data driving unit 300 and the timing controller 510. According to an exemplary embodiment of the present invention, the first and second connection units FC1 and FC2 may be flexible printed circuit boards.

The driving circuit board 500 may generate signals for driving the display device 1000a. More specifically, the driving circuit board 500 includes the timing controller 510.

The timing controller 510 may output driving signals in response to external control signals. For example, the timing controller 510 may generate a first data control signal D-CS1, a second data control signal D-CS2, and a gate control signal G-CS. Each data control signal may include an output start signal, a clock signal, etc. The gate control signal G-CS may include a vertical start signal, a vertical clock bar signal, etc.

The timing controller 510 may transmit the first control signal D-CS1 to the data driving unit 300 through the first connection unit FC1. The timing controller 510 may transmit the second control signal D-CS2 to the data driving unit 300 through the second connection unit FC2. In addition, the timing controller 510 may transmit the gate control signal G-CS to the gate driving circuit 200 through the first connection unit FC1. For example, the timing controller 510 may transmit the gate control signal G-CS through the first data driving chip 300_1 illustrated in FIG. 1.

The timing controller 510 may generate first and second image signals R′G′B′1 and R′G′B′2. The timing controller 510 may transmit the first image signals R′G′B′1 through the first connection unit FC1, and transmit the second image signals R′G′B′2 through the second connection unit FC2.

Although FIG. 2 illustrates that the first and second connection units FC1 and FC2 connect the display panel 100 and the driving circuit board 500, according to an exemplary embodiment of the present, at least one connection unit may be used to connect the display panel 100 and the driving circuit board 500.

According to an exemplary embodiment of the present invention, the first data control signal D-CS1 and the first image signals R′G′B′1 may be supplied to the data driving chips in a first area of the data driving chips through the first connection unit FC1. The data driving chips in the first area may supply the data voltages corresponding to the first image signals R′G′B′1 to the corresponding data lines in the first area of the data lines, in response to the first data control signal D-CS1.

According to an exemplary embodiment of the present invention, the second data control signal D-CS2 and the second image signals R′G′B′2 may be supplied to the data driving chips in a remaining second area of the data driving chips through the second connection unit FC2. The data driving chips in the second area may supply the data voltages corresponding to the second image signals R′G′B′2 to the corresponding data lines in the second area of the data lines, in response to the second data control signal D-CS2.

According to an exemplary embodiment of the present invention, the timing controller 510 may be electrically connected to the power supply unit 400 through the first connection unit FC1. The power supply unit 400 may supply a control driving voltage TVDD required to operate the timing controller 510 to the timing controller 510 through the first connection unit FC1.

Although the power supply unit 400 is described as generating the driving voltages required to operate the gate driving circuit 200, the data driving unit 300, and the timing controller 510, according to an exemplary embodiment of the present invention, the power supply unit 400 may generate driving voltages required to drive the display device 1000a.

As mentioned above, the power supply unit 400 according to the exemplary embodiments of the present invention may not be mounted on a typical driving circuit board 500, but mounted on the peripheral area PA of the display panel 100 to reduce the size of the driving circuit board 500. In addition, as a display device becomes larger, additional components may further be mounted on the driving circuit board 500.

FIG. 3 is a block diagram of a display device according to an exemplary embodiment of the present invention.

Referring to FIG. 3, in a display device 1000b according to an exemplary embodiment of the present invention, a power supply unit 400 may be mounted on an area of the display device 1000b that is different to the display device 1000a illustrated in FIG. 1. Operations and structures of components of the display device 1000b other than the power supply unit 400 may substantially be the same as those of the display device 1000a illustrated in FIG. 1, and accordingly, repeated description of the substantially the same components will be omitted.

The power supply unit 400 may generate a gate driving voltage Vg, an analog driving voltage AVDD, and a control driving voltage TVDD. The power supply unit 400 may be electrically connected to a gate driving circuit 200 to supply the gate driving voltage Vg to the gate driving circuit 200. FIG. 3 illustrates that the power supply unit 400 is directly connected to the gate driving circuit 200 to supply the gate driving voltage Vg, however, according to an exemplary embodiment of the present, the power supply unit 400 may supply the gate driving voltage Vg to the gate driving circuit 200 through a data driving unit 300, as similar to the gate control signal G-CS. The power supply unit 400 is electrically connected to the data driving unit 300 to supply an analog driving voltage AVDD to the data driving unit 300. The power supply unit 400 is electrically connected to a timing controller 510 and supplies a control driving voltage TVDD to the timing controller 510.

According to an exemplary embodiment of the present invention, the power supply unit 400 of the display device 1000b may be mounted on a first connection unit FC1 between the first and second connection units FC1 and FC2, so that the gate driving circuit 200 is closer in distance to the first connection units FC1 than the second connection unit FC2. More particularly, an interconnection that electrically connects the gate driving circuit 200 and the power supply unit 400 is shorter when the power supply unit 400 is mounted on the first connection unit FC1, rather than when the power supply unit 400 is mounted on the second connection unit FC2. In this case, the display device 1000b is described to include a single gate driving circuit 200.

Although not illustrated in FIG. 3, when the display device 1000b includes two gate driving circuits 200 connected to both ends of gate lines (GL1 through GLn), the power supply units 400 may be mounted on each of the first and second connection units FC1 and FC2.

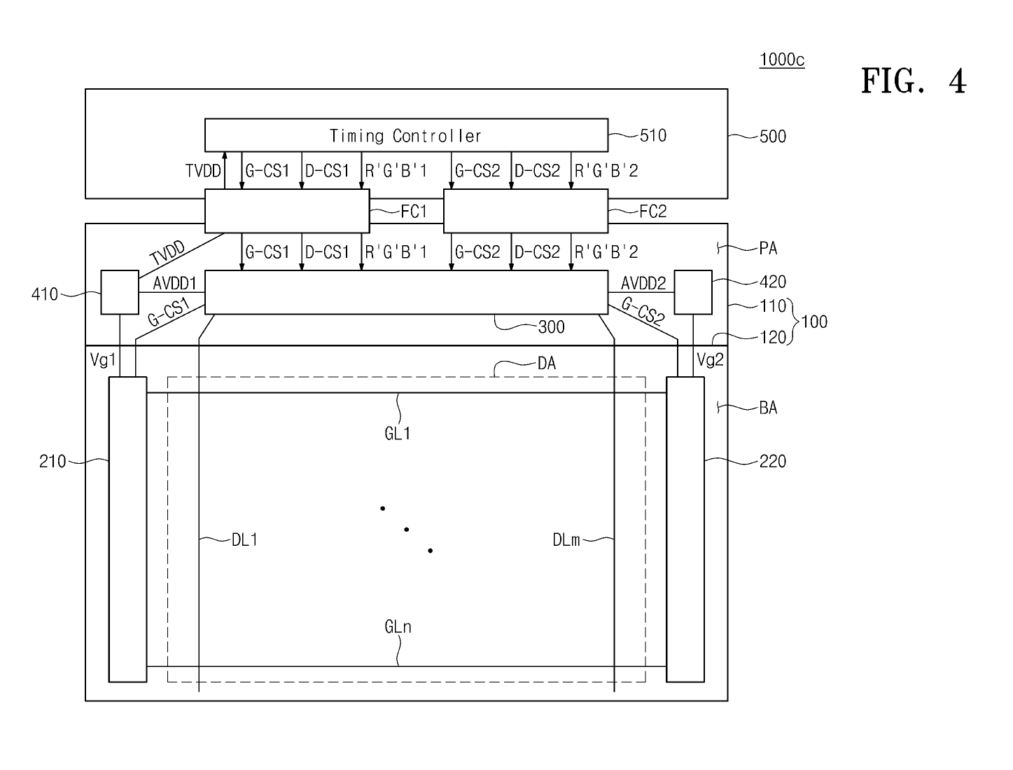

FIG. 4 is a block diagram of a display device according to an exemplary embodiment of the present invention.

Referring to FIG. 4, a display device 1000c according to an exemplary embodiment of the present invention may further include additional power supply unit and a gate driving circuit, as compared to the display device 1000a illustrated in FIG. 1. For example, the display device 1000a illustrated in FIG. 1 may be a small-sized display device, while the display device 1000c illustrated in FIG. 3 may be a large-sized display device.

More specifically, a first gate driving circuit 210 and a second gate driving circuit 220 are mounted on a black matrix area BA of a display panel 100. In this case, the first gate driving circuit 210 may be disposed adjacent to one end portion of each of the gate lines (GL1 through GLn) with respect to a display area DA, and the second gate driving circuit 220 may be disposed adjacent to the other end portion of each of the gate lines (GL1 through GLn) with respect to the display area DA.

A timing controller 510 may generate a first gate control signal G- CS1 that is supplied to the first gate driving circuit 210, and a second gate control signal G-CS2 that is supplied to the second gate driving circuit 220. The timing controller 510 may transmit the first gate control signal G-CS1 to the first gate driving circuit 210 through a first connection unit FC1 and a data driving unit 300. The timing controller 510 may transmit the second gate control signal G-CS2 to the second gate driving circuit 220 through a second connection unit FC2 and the data driving unit 300.

According to an exemplary embodiment of the present invention, a first power supply unit 410 and the second power supply unit 420 are mounted on a peripheral area PA of a first substrate 110. The first and second gate driving circuits 210 and 220 may be directly formed on a black matrix area BA of the first substrate 110, through a thin-film process which forms a thin-film transistor of a pixel.

The first power supply unit 410 is mounted to be adjacent to a left end portion of the peripheral area PA, so that the first power supply unit 410 may be electrically connected to the first gate driving circuit 210, the data driving unit 300, and the first connection unit FC1. More specifically, the first power supply unit 410 may be electrically connected to the first gate driving circuit 210 to supply a first gate driving voltage Vg1 to the first gate driving circuit 210, electrically connected to the data driving unit 300 to supply a first analog driving voltage AVDD1 to the data driving unit 300, and electrically connected to the timing controller 510 to supply a control driving voltage TVDD to the timing controller 510.

The second power supply unit 420 is mounted to be adjacent to a right end portion of the peripheral area PA, so that the second power supply unit 420 is electrically connected to the second gate driving circuit 220 and the data driving unit 300. More specifically, the second power supply unit 420 may be electrically connected to the second gate driving circuit 220 to supply a second gate driving voltage Vg2 to the second gate driving circuit 220, and electrically connected to the data driving unit 300 to supply a second analog driving voltage AVDD2 to the data driving unit 300.

As described above, the display device 1000c illustrated in FIG. 4 may have a structure in which the first and second power supply units 410 and 420 are disposed on the peripheral area PA.

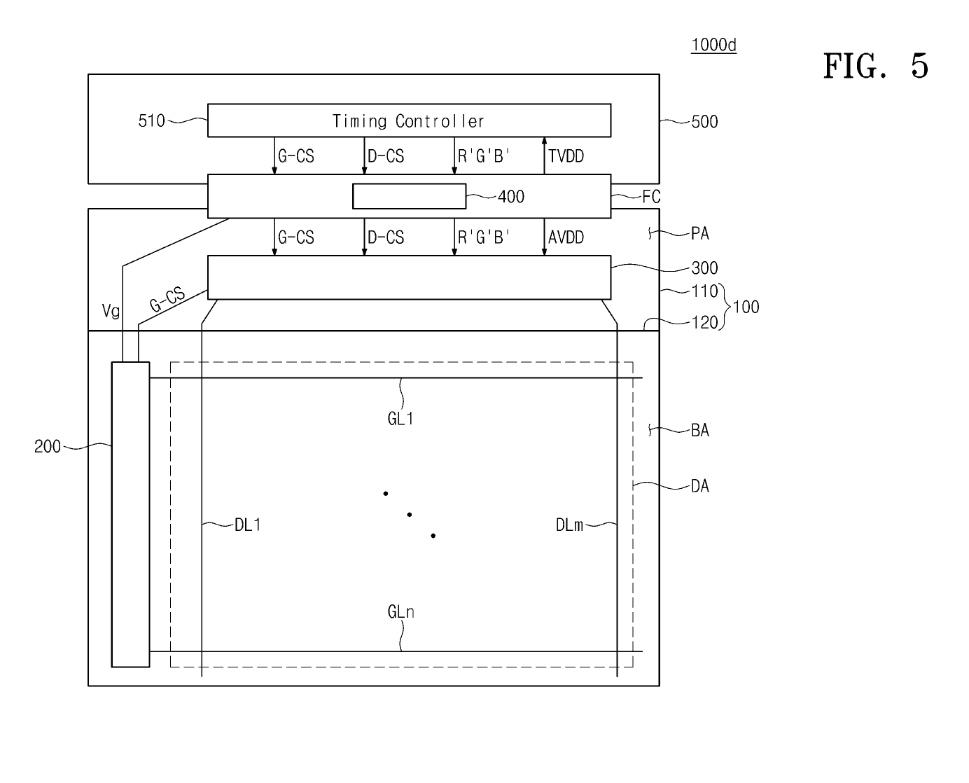

FIG. 5 is a block diagram of a display device according to an exemplary embodiment of the present invention.

Referring to FIG. 5, in a display device 1000d according to an exemplary embodiment of the present invention, a driving circuit board 500 and a display panel 100 may be electrically connected through a single connection unit FC, as compared to the display device 1000a illustrated in FIG. 1. One end of the connection unit FC may overlap with and connected to the driving circuit board 500, and the other end of the connection unit FC may overlap with and connected to a peripheral area PA of the display panel 100.

A power supply unit 400 may be mounted on the connection unit FC. The power supply unit 400 may be electrically connected to a gate driving circuit 200, a data driving unit 300, and a timing controller 510. The power supply unit 400 supplies a gate-on voltage Vg to the gate driving circuit 200, an analog driving voltage AVDD to the data driving unit 300, and a control driving voltage TVDD to the timing controller 510.

As mentioned above, the power supply unit 400 according to an exemplary embodiment of the present invention may not be mounted on a typical driving circuit board 500, but mounted on a peripheral area PA of the display panel 100 or on a connection unit FC. As a result, the overall size of the driving circuit board 500 may be reduced to increase the overall size of the display panel 100.

In addition, as the power supply unit 400 is mounted on the peripheral area PA, voltage loss of the gate driving voltage Vg supplied to the gate driving circuit 200 may be decreased, as an interconnection that electrically connects the gate driving circuit 200 and the power supply unit 400 is shorter when the power supply unit 400 is mounted on the peripheral area PA than when the power supply unit 400 is mounted on the driving circuit board 500.

According to the exemplary embodiments of the present invention, a power supply unit mounted on a printed circuit board may be mounted on a display panel to reduce the overall size of the printed circuit board.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A display device, comprising:
a first substrate comprising pixels;
a second substrate connected to and facing the first substrate; and
a power supply unit disposed on a peripheral area of the first substrate that does not overlap the second substrate.

2. The display device of claim 1, further comprising data driving chips disposed on the peripheral area of the first substrate by a chip-on-glass method.

3. The display device of claim 2, wherein the power supply unit is electrically connected to the data driving chips and configured to supply an analog driving voltage to the data driving chips.

4. The display device of claim 1, wherein the first substrate further comprises:
a display area on which images are configured to be displayed; and
a black matrix area surrounding the display area.

5. The display device of claim 4, further comprising a gate driving circuit disposed on the black matrix area.

6. The display device of claim 5, wherein the power supply unit is electrically connected to the gate driving circuit to supply a gate-on voltage to the gate driving circuit.

7. The display device of claim 4, wherein gate lines electrically connected to the pixels and data lines insulated from and crossing the gate lines are disposed on the display area and the black matrix area.

8. The display device of claim 7, further comprising:
a first gate driving circuit; and
a second gate driving circuit disposed on the black matrix area.

9. The display device of claim 8, wherein:
the first gate driving circuit is connected to a first end of each of the gate lines; and
the second gate driving circuit is connected to a second end of each of the gate lines, the first end being opposite to the second end.

10. The display device of claim 8, further comprising an auxiliary power supply unit disposed on the peripheral area,
wherein:
the power supply unit is configured to supply a first gate-on voltage to the first gate driving circuit; and
the auxiliary power supply unit is configured to supply a second gate-on voltage to the second gate driving circuit.

11. A display device, comprising:
a first substrate comprising pixels;
a second substrate connected to and facing the first substrate;
a driving circuit board electrically connected to the first substrate;
a connection unit electrically connecting the first substrate and the driving circuit board; and
a power supply unit disposed on the connection unit.

12. The display device of claim 11, wherein the connection unit comprises at least one flexible circuit board.

13. The display device of claim 12, wherein:
the connection unit comprises first and second flexible circuit boards;
the power supply unit comprises a first power supply unit and a second power supply unit; and
s the first and second power supply units are disposed on the first and second flexible circuit boards, respectively.

14. The display device of claim 12, wherein the power supply unit is disposed on the at least one flexible circuit board.

15. The display device of claim 11, wherein the second substrate comprises a common electrode.

16. The display device of claim 11, further comprising a gate driving circuit disposed on a black matrix area of the first substrate,
wherein the black matrix area surrounds a display area of the first substrate.

17. The display device of claim 16, wherein:
the connection unit comprises a first flexible circuit board and a second flexible circuit board;
the power supply unit is disposed on the first flexible circuit board; and
a first distance from the first flexible circuit board to the gate driving circuit is less than a second distance from the second flexible circuit board to the gate driving circuit.

18. The display device of claim 17, wherein:
the power supply unit is electrically connected to the gate driving circuit to supply a gate-on voltage to the gate driving circuit;
the gate driving circuit is connected to gate lines disposed on the black matrix area; and
the gate lines are electrically connected to the pixels.

19. The display device of claim 18, wherein a third distance from the power supply unit to the gate driving circuit is less than a fourth distance from the driving circuit board to the gate driving circuit.

20. The display device of claim 16, wherein a first distance from the power supply unit to the gate driving circuit is less than a second distance from the driving circuit board to the gate driving circuit.
